(19) United States
(12) Patent Application Publication
(10) Pub. No.: US 2021/0394769 A1
(43) Pub. Date: Dec. 23, 2021

(54) Preparing a Motor Vehicle for Operation

(71) Applicant: Bayerische Motoren Werke Aktiengesellschaft, Muenchen (DE)

(72) Inventors: Sebastian KALUZA, Muenchen (DE); Enrique MARCIAL-SIMON, Veitshoechheim (DE)

(21) Appl. No.: 17/292,787

(22) PCT Filed: Nov. 22, 2019
(86) PCT No.: PCT/EP2019/082172

§ 371 Date: May 11, 2021

(30) Foreign Application Priority Data
Nov. 26, 2018 (DE) 10 2018 129 699.1

(51) Int. Cl. B60W 50/00; B60H 1/00; B60K 11/00; B60R 16/023

(52) U.S. Cl. CPC B60W 50/0097; B60H 1/00778; B60K 6/22; B60K 11/00; B60R 16/0231; B60H 1/00657

(57) ABSTRACT

A motor vehicle includes a first time switch and a second time switch for controlling a preparation function for an operation of the motor vehicle. A set first time switch overrides a set second time switch. A method for controlling the preparation function includes determining an expected utilization time of the motor vehicle; determining that the first time switch is not set; outputting a specific utilization time and detecting a confirmation of the specific utilization time; and setting the first time switch to the specific utilization time.

### BACKGROUND AND SUMMARY OF THE INVENTION

The invention relates to preparing a motor vehicle for its operation. In particular, the invention relates to preparing the motor vehicle for its operation in a time-controlled manner.

A motor vehicle can be prepared for its operation by preheating an interior by using an auxiliary heating system, for example. The auxiliary heating system can additionally burn fuel which can also be used for operating an internal combustion engine for driving the motor vehicle. A time switch can be provided for controlling the preparation, which time switch can be manually set by a user of the motor vehicle to a predetermined time at which they would like the preparation of the motor vehicle. The time switch can also offer the option to control the preparation on a daily basis at the same time. The preparation may also be controlled on selectable weekdays of a week at the same time in each case.

Known controls for preparing a motor vehicle for an operation have proven to not be very flexible. By using modern technology, an upcoming utilization time can be predetermined with a good level of accuracy, nevertheless, coordinating the automatically determined utilization time with a manual setting by a user of the motor vehicle is often difficult to reconcile.

One underlying object of the invention involves specifying a technology by which the preparation of a motor vehicle for an operation can be controlled in an improved manner. The claimed invention achieves the object.

A motor vehicle comprises a first time switch and a second time switch for controlling a preparatory function for an operation of the motor vehicle, wherein a set first time switch overrides a set second time switch. According to a first aspect of the present invention, a method for controlling the preparatory function comprises determining an expected utilization time of the motor vehicle; determining that the first time switch is not set, outputting the specific utilization time and detecting a confirmation of the utilization time; as well as setting the first time switch to the confirmed utilization time.

The second time switch can be provided for preparing the motor vehicle for a regular operation. For this purpose, the second time switch can in particular control a recurrent preparation, for example on a daily basis or on one or a plurality of predetermined weekdays. A plurality of second time switches may also be provided which can each control recurrent preparations. If, for example, three second time switches are provided, up to three preparations of the motor vehicle can be controlled on the same day.

The first time switch can be available for a more direct input of a time controlled preparation of the motor vehicle. This enables a quick input of a planned utilization time, for example by a driver when leaving the motor vehicle.

If the first time switch is not set, it can be used in order to carry out a preparation of the motor vehicle on the basis of an automatically determined utilization time. The upcoming utilization can, for example, be determined on the basis of earlier utilizations of the motor vehicle by a user, on the basis of earlier utilizations of other motor vehicles by a user associated with the motor vehicle or on the basis of other heuristics. In this case, the preparation is preferably not directly controlled, but rather a specific utilization time is firstly offered to a user of the motor vehicle, which may be accepted, changed or rejected.

The method can be used in a flexible manner in order to effectively integrate the preparation of the motor vehicle for its operation on the basis of an automatically determined utilization time with setting the second time switch. Both time switches can already be provided on board the motor vehicle, so that the method can be implemented or upgraded with minimal effort. By using the priority function of the first time switch, it is possible to prevent the preparation from being carried out more often than required. In particular, a preparation can be prevented from taking place between a time at which the upcoming utilization time is determined and the actual utilization time. Preparing the motor vehicle based on a setting of the second time switch can be overridden in this time domain.

It is preferably determined that the first time switch is not set or has been set by an earlier execution of the method. This logical connection makes it possible to change, correct or supplement a preceding determination of a utilization time within the context of the method. A time switch which is set manually by a user, for example, can remain unchanged by the method. In this case, a proposal for setting the first time switch is preferably not output. The first time switch can also remain unchanged for use by a different control device or a different service.

It is further preferably determined that the first time switch is set and that the specific utilization time is temporally before the utilization time of the first time switch. This logical connection makes it possible to avoid unintentionally deleting a utilization time which is already entered. Utilization safety of the method can be improved. A user can use the method more intuitively.

If the first time switch is set, a utilization time of the first time switch can be stored in a storage device; and the first time switch can be set to the specific utilization time. The first time switch can be set to the stored utilization time after the first time switch has expired. In this way, a utilization time can be reserved without losing or overwriting a utilization time which is already reserved.

A plurality of utilization times of the first time switch is preferably stored in a storage device, wherein the first time switch, after expiration, is set to the temporally next utilization time in the storage device, and this utilization time is deleted from the storage device. Utilization times which are saved in the storage device can in particular be present sorted according to their utilization times, such that a queue can be realized. The size of the queue can be suitably selected in order to make it possible to manage a predetermined number of utilization times. Optionally, utilization times which are recorded in the storage device can also be managed, for example by a user of the motor vehicle. In this case, a utilization time can be reviewed, manipulated or deleted. The user can also read or write utilization times which have been determined with respect to another user.

A utilization time of the first time switch can also be stored in an external device. In particular, the external site can comprise a remote storage device, a server or a service which can be realized in a cloud, for example. The external site can be set up to save or manage further information which relates to the motor vehicle or to a user of the motor vehicle. As a result, information can be better correlated. In particular, determining the utilization time can be carried out in an improved manner on the basis of a wide database of the remote site.

The preparatory function can relate to one of heating, cooling or ventilating (HVAC: heating, ventilation, air conditioning) an interior of the motor vehicle. The interior of the motor vehicle can therefore be prepared for a user irrespective of the prevailing weather. The user can immediately feel comfortable and use the motor vehicle right away.

The preparatory function can relate to a driving operation of the motor vehicle. An aggregate of the motor vehicle which is required for the driving operation can in particular be prepared for this purpose. In particular, the preparatory function can relate to a temperature control of a drive system. In one embodiment, the motor vehicle can be driven by an internal combustion engine which, within the context of the preparation, can be heated in order to be able to be started up in an improved manner or in order to be able to reach its operating temperature more quickly after starting up the engine. A lifespan of the internal combustion engine can be extended and the power which can be accessed before reaching the operating temperature can be increased.

In another embodiment, the motor vehicle comprises an electrical drive motor which can be supplied by an electrical energy storage device. In this case, the preparation can relate to heating the energy storage device, so that it is able to emit electrical energy in an improved manner at the time of use. An amount of energy which can be provided by the energy storage device can be increased in this way. In addition, the energy storage device can be preserved in this way, so that it can achieve an improved efficiency and/or an extended lifespan. The energy storage device may also require preheating in order to be able to provide electrical energy at all. For example, the energy storage device can comprise a fuel cell and require an operating temperature of several 100° C. The fuel cell can be supplied with fuel gas which can be provided by a reformer from diesel oil at high temperatures, and preparation can comprise heating the reformer.

According to a further aspect of the invention, a control device for a motor vehicle for preparing an operation of the motor vehicle depending on a first and a second time switch, wherein a set first time switch overrides a set second time switch, comprises the following elements: an interaction device for a user; an interface to the first time switch; and a processing device. In this case, the processing device is set up to determine an expected utilization time of the motor vehicle; to determine that the first time switch is not set; to output the specific utilization time and to detect a confirmation of the utilization time; and to set the first time switch to the confirmed utilization time.

The processing device can in particular be set up to carry out, in whole or in part, a method described herein. For this purpose, the processing device can comprise a programmable microcomputer or microcontroller and the method can be present in the form of a computer program product with program code. The computer program product may also be stored on a computer-readable data carrier. Features or advantages of the method can be transferred to the device or vice versa.

The control device for preparing the operation of the motor vehicle can be operated by electrical energy of an electrical energy storage device which is provided for operating a traction drive of the motor vehicle. The motor vehicle can be set up for pure or hybrid electric operation, so that an amount of energy which can be accessed before actual use of the motor vehicle can be large. In particular, an interior of the motor vehicle can be cooled by an air conditioning system in preparation for use. During operation, the air conditioning system can receive approximately 1-5 kW which usually cannot be provided for a sufficient period of time by an energy storage device on board a motor vehicle, which is driven with an internal combustion engine, when the drive motor is switched off in order to ensure efficient cooling and/or a safe start of the drive motor.

According to one further aspect of the invention, a motor vehicle comprises a control device described herein.

According to yet another further aspect of the invention, a system comprises a control device described herein and an external site described herein. In this case, the external site is, at least temporarily, communicatively connected with the control device.

The invention is now described more precisely with reference to the accompanying drawings.

### BRIEF DESCRIPTION OF THE DRAWINGS

FIG. 1 illustrates a system.

FIG. 2 illustrates a flow diagram of a method.

### DETAILED DESCRIPTION OF THE DRAWINGS

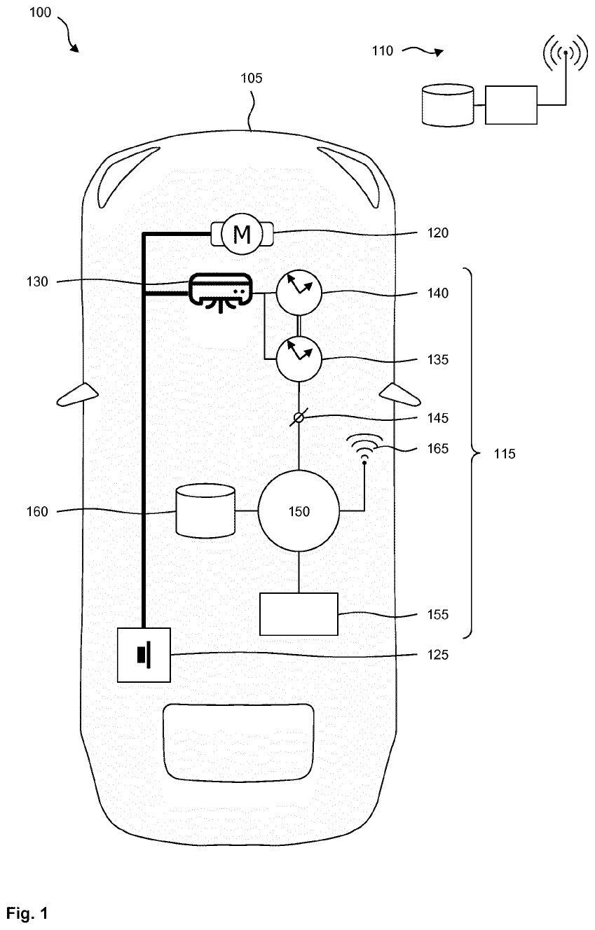

FIG. 1 shows a system 100 which comprises a motor vehicle 105 and an external site 110. On board the motor vehicle 105, a control device 115 is provided which is set up to determine an upcoming utilization time of the motor vehicle 105 and, preferably depending on this, to control a preparatory function of the motor vehicle 105 for its operation or its use.

The motor vehicle 105 can be driven by a traction drive 120. The traction drive 120 can comprise an internal combustion engine or an electrical drive motor. In addition, an electrical energy storage device 125 is preferably provided which can be used for operating the electrical traction drive 120 or a different aggregate.

A device 130 is provided for preparing an operation of the motor vehicle 105. The device 130 is particularly preferably intended for heating, cooling or ventilating an interior, a drive component 120 or the energy storage device 125 of the motor vehicle 105. Purely as an example, the device 130 is represented symbolically as an air conditioning system. It is particularly preferable that the device 130 can be operated by electrical energy from the energy storage device 125.

The device 130 can be controlled manually or in a time-based manner. A first time switch 135 and a second time switch 140 are preferably provided for this purpose which can each be loaded with a utilization time of the motor vehicle 105. If the loaded utilization time is reached, a preparatory function can be controlled by the device 130. The time switches 135 and 140 are further preferably connected to one another in such a way that the second time switch 140 cannot trigger the preparatory function if the first time switch 135 is loaded with a utilization time. The second time switch 140 can therefore be practically inhibited by the first time switch 135 or overridden in its function.

The second time switch 140 is preferably a periodic time switch and can support recurrent utilization times, in order to control a preparation of the motor vehicle 105 on predetermined days of a week at the same time in each case, for example. A plurality of second time switches 140 can also be provided, wherein mutual dependencies or an expected duration of a preparation can be taken into account. This makes is possible to prevent a preparation of the motor vehicle 105 from being controlled while a preparation is already taking place, for example. In contrast, the first time switch 135 is preferably a one-time time switch which, after reaching the time which is loaded into it, only triggers the preparatory function once and then deactivates itself, such that it is no longer considered to be set or deletes the time which is loaded into it.

The control device 115 is preferably connected to the first time switch 135 and/or the second time switch 140 by an interface 145 and can access it in a reading and/or writing manner. In particular, an upcoming time at which the preparatory function is to be controlled can be read and/or or written. In the case of the second time switch 140, a period duration between recurrent times can also be read and/or written. Further information can be associated with a set time of this type and the information can also be read and/or written.

It is preferable that individual times within a predetermined observation period can be exposed. The observation period can in particular be a week and the period duration can be a day. The second time switch 140 can therefore be set in such a way that within a week it triggers daily at the same time, wherein days on which triggering takes place can be selected individually.

A processing device 150 is connected to the interface 145, as well as preferably to an interaction device 155, a storage device 160 and/or a communication device 165. The optional interaction device 155 is set up to enable an output to a user and/or an input of the user. The interaction device 155 can be comprised of a different system on board the motor vehicle 105 and can in particular have a touchscreen. The optional storage device 160 is set up to save one or a plurality of utilization times. Optionally, other or additional information can also be saved in the storage device 160. Relevant information can also be obtained from the external site 110 by the communication device 165. The communication device 165 can in particular use a mobile network and/or the internet in order to operate a communication connection with the external site 110.

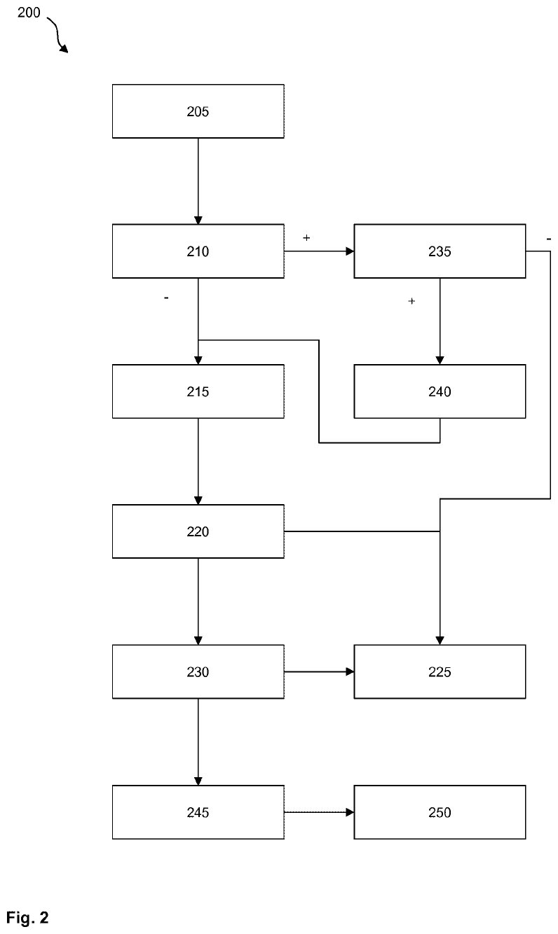

FIG. 2 shows a flow diagram of an exemplary method 200 which can in particular be carried out using the control device 115. The specified sequence of the steps shown can vary in different embodiments, as recognized easily by a person skilled in the art. Not all embodiments described herein are set out in the present flow diagram.

At step 205, an expected utilization time of the motor vehicle 105 is determined. For this purpose, a statistical observation of the habits of a user associated with the motor vehicle 105 or of past uses of the motor vehicle 105 can be carried out. Uses can be correlated with other information, for example a calendar entry, the prevailing weather or a position of the motor vehicle 105. If, for example, it is known that a journey is undertaken every weekday which terminates at a predetermined time at a predetermined location, a probable departure time can be determined on the basis of a position of the motor vehicle 105 and an anticipated journey time to the predetermined location.

At step 210, it is determined whether the first time switch 135 is set, i.e. loaded with a predetermined utilization time.

If the first time switch 135 is not set, the utilization time, which was determined at step 205, can be output to a user of the motor vehicle 105 as a proposal at step 215. The output can take place by the interaction device 155, and preferably towards the end of a journey which precedes the specific utilization time. For example, the steps 205 to 215 can always be carried out when parking the motor vehicle 105. In one other embodiment, the interaction with the user can also take place if the user is not on board the motor vehicle 105. In this case, a mobile phone (smartphone) can in particular be used as an interaction device 155 and can be in direct or indirect communicative connection with the control device 115.

It is particularly preferable that the output proposal comprises a justification which describes its realization. In the above example, it may be pointed out that it is probable that a commute is imminent or that a departure time has been determined on the basis of a traffic forecast or weather forecast. At step 220, a confirmation of the proposed utilization time can be detected. The user can also change a proposal before confirmation. If the user rejects the proposal, the method may end at step 225.

If there is a confirmed utilization time, the first time switch 135 can be set to the utilization time at step 230. In this case, for reasons of simplicity, it is assumed that a utilization time is synonymous with the time at which a preparatory function of the motor vehicle 105 is controlled. If it is anticipated that the preparation of the motor vehicle 105 takes a certain duration, the preparation can commence around this amount of time earlier than the specified utilization time. The duration can depend on external circumstances, in particular on the weather or desired conditions on board the motor vehicle 105 which are pre-set by a user.

If it has been determined at step 210 that the first time switch 135 is already set, it can be reviewed at step 235 whether the first time switch 135 has been set by the method 200. For this purpose, when setting the first time switch 135, an indication of a writing component can be stored in addition to the utilization time. Alternatively, the utilization time can be saved in a parallel manner in a further storage device, in particular in the storage device 160, when setting the first time switch 135 by way of the method 200. If, during a subsequent review, the utilization time in the further storage device corresponds precisely to the utilization time of the first time switch 135, it can be inferred that the first time switch 135 has been set by the method 200. If the first time switch 135 was not set by the method 200, but rather in particular by a user, the method may end at step 225.

Alternatively, the utilization time can be read from the first time switch 135 and saved in the storage device 160 at step 240. Steps 215 to 225 can subsequently proceed, in which a confirmation of a user is obtained and the specific utilization time is loaded into the first time switch 135.

If the first time switch 135 expires, i.e. an actual time reaches the time predetermined by the set utilization time, the expiration can be determined at step 245 and, at step 250, the first time switch 135 can be set to the utilization time stored previously. In one preferred embodiment, a plurality of utilization times can be saved in the storage device 160. At step 255, that utilization time which is entered as the first one of all stored utilization times, i.e. the earliest utilization time, is loaded into the first time switch 135 and deleted from the storage device 160.

### REFERENCE NUMBERS

100 system
105 motor vehicle
110 external site
115 control device
120 traction drive
125 electrical energy storage device
130 device
135 first time switch
140 second time switch
145 interface
150 processing device 155 interaction device
160 storage device
165 communication device
200 method
205 determining utilization time
210 first time switch set?
215 output proposal
220 detect confirmation
225 end
230 set first time switch to utilization time
235 first time switch set by method?
240 store utilization time
245 determining expiration of first time switch
250 set first time switch to stored utilization time

1. to 12. canceled

13. A method for controlling a preparatory function for an operation of a motor vehicle which comprises a first time switch and a second time switch for controlling the preparatory function, wherein a set first time switch overrides a set second time switch, the method comprising:
determining an expected utilization time of the motor vehicle;
determining whether the first time switch is set;
outputting a specific utilization time and detecting a confirmation of the specific utilization time; and
setting the first time switch to the specific utilization time.

14. The method according to claim 13, wherein it is determined that the first time switch is not set or has been set by an earlier execution of the method.

15. The method according to claim 13, wherein it is determined that the first time switch is set, and the specific utilization time is temporally before a utilization time of the first time switch.

16. The method according to claim 13, wherein, if the first time switch is set, a utilization time of the first time switch is stored; the first time switch is set to the specific utilization time; and the first time switch is set to the stored utilization time after the first time switch has expired.

17. The method according to claim 16, wherein a plurality of utilization times of the first time switch are stored in a storage device;
the first time switch, after expiration, is set to the temporally next utilization time in the storage device; and
the temporally next utilization time is subsequently deleted from the storage device.

18. The method according to claim 16, wherein the utilization time of the first time switch is stored in an external device.

19. The method according to claim 13, wherein the preparatory function relates to at least one of heating, cooling or ventilating an interior of the motor vehicle.

20. The method according to claim 13, wherein the preparatory function relates to a temperature control of a drive system.

21. A control device for a motor vehicle, wherein the control device is configured to prepare an operation of the motor vehicle depending on a first time switch and a second time switch, wherein a set first time switch overrides a set second time switch, the control device comprising:
an interaction device for a user;
an interface to the first time switch; and
a processing device which is configured to:
determine an expected utilization time of the motor vehicle;
determine that the first time switch is not set;
output a specific utilization time and detect a confirmation of the specific utilization time; and
set the first time switch to the specific utilization time.

22. The control device according to claim 21, wherein the control device is configured to be operated by electrical energy of an electrical energy storage device which is provided for operating a traction drive of the motor vehicle.

23. A motor vehicle comprising the control device according to claim 13.

24. A system comprising a control device according to claim 13 and an external site which is communicatively connected with the control device.
